(19) United States
(12) Patent Application Publication
(10) Pub. No.: US 2024/0011569 A1
(43) Pub. Date: Jan. 11, 2024

(54) BALL VALVE

(71) Applicant: CASTEL S.R.L., Milano (IT)

(72) Inventors: Lucrezia DABANELLO, Milano (IT); Giorgio MONACA, Milano (IT)

(21) Appl. No.: 18/253,692

(22) PCT Filed: Nov. 30, 2021
(86) PCT No.: PCT/IB2021/061120

§ 371 Date: May 19, 2023

(30) Foreign Application Priority Data
Nov. 30, 2020 (IT) 102020000029099

(51) Int. Cl. F16K 5/06; F16K 27/06; F16K 27/10

(52) U.S. Cl. CPC F16K 5/0642; F16K 27/067; F16K 27/107

(57) ABSTRACT

A ball valve (1; 100) comprising a body (2; 102) delimiting an internal cavity, a plug (3; 103) configured to be permanently connected to the body (2; 102), for partially closing the internal cavity, a ball shutter (5) housed in the internal cavity, a first connecting element (18; 118) configured as a hollow tubular element in fluid communication with the ball shutter (5) and wherein the plug (3; 103) comprises a second connecting element (20; 120) configured as a hollow tubular element in fluid communication with the ball shutter (5), wherein the body (2; 102) and the first connecting element (18; 118) together define a monobloc body and wherein the plug (3; 103) and the second connecting element (20; 120) together define a monobloc body without welds.

The present invention relates to a flow interception device configured as a ball valve.

In the following description explicit reference will be made to a ball valve that can be used in a refrigeration plant, although it is understood that it can be used in other types of hydraulic circuits.

In a refrigeration system, high operating pressures are reached and, for this reason, the components used must have a high mechanical resistance to guarantee the hydraulic seal and their correct functioning.

A ball valve is a shut-off device configured primarily to allow or prevent or sometimes to partialize the passage of a flow through it.

The body of the ball valve defines a seat for housing a ball shutter and annular seals configured to define a seal between the seat and the shutter itself.

The ball shutter has a through circular opening so that the rotation of the ball inside the body allows to align the hole with the pipes to which the ball valve is applied or to misalign it, respectively, to allow or prevent the fluid passage.

The ball valve includes a command bound to the ball in such a way that by rotating this command the rotation of the ball shutter is determined. For example, this command comprises a pin housed rotatable in the valve body, wherein the pin has one end that engages a seat made at the top portion of the ball shutter and an opposite end that protrudes from the valve body.

There are hydraulic sealing elements between the pin and the valve body.

In general, the body of the ball valve includes two components connected to each other and configured to delimit the seat for housing the shutter, the sealing gaskets as well as the seat for the control pin. A first tubular element and a second tubular element are then connected and welded to the opposite ends of the valve body, which act as elements for connecting the ball valve with a duct of the circuit to be intercepted.

The components that make up the ball valve body as well as the first and second connections are made of metal. For example, the body components can be made of brass or steel while the connections can be made of copper or steel.

Ball valves are widely used in the refrigeration sector, as well as in other sectors of industry.

The known solutions, however, require high production times with reference to the need to weld the individual components together so as not only to guarantee their mechanical connection but, above all, their hydraulic seal.

Documents US 2014/0021176A1 and US 2015/0159763 A1 describe some examples of traditional ball valves, each comprising individual components, namely the body containing the shutter, the plug and tubular connection elements, welded together.

The use of different materials for the construction of the valve body and the connection elements requires particular attention in the execution of the welds to ensure the required tightness and resistance.

There is a need in the sector to have a ball valve of more practical construction and capable of ensuring high performance, with reference to the operating pressures of the ball valve.

The object of the present invention is to provide a ball valve with high mechanical and hydraulic performance in a simple, efficient and practical way.

Another object of the present invention is to provide a ball valve the assembly of which is practical and easy to make with respect to that of traditional solutions.

A further object of the present invention is to provide a ball valve capable of ensuring the hydraulic seal between the components that compose it.

The specific object of the invention is a ball valve comprising:
a body delimiting an internal cavity,
a plug configured to be permanently connected to the body for a partial closure of the internal cavity,
the body being configured to house in the internal cavity a ball shutter which can be rotated around an actuation axis,
wherein the body comprises a first connecting element configured as a hollow tubular element in fluid communication with the ball shutter,
and wherein the cap comprises a second connecting element configured as a hollow tubular element which, when the cap is bound to the body, is in fluid communication with the ball shutter,
wherein the body and the first connecting element together define a monobloc body without welds and wherein the cap and the second connecting element together define a monobloc body without welds.

According to another aspect of the invention, the body and the first connecting element can be a monobloc and continuous body and the cap and the second connecting element can be a monobloc and continuous body.

According to a further aspect of the invention, the body and the cap can be mutually sealed by means of a circumferential welding.

According to an additional aspect of the invention, the first connecting element and the second connecting element can protrude from opposite ends of the valve, mutually aligned along a flow direction.

According to another aspect of the invention, the body and the plug can be made of steel.

According to a further aspect of the invention, the first connecting element can have a connection portion which extends for at least a portion of the first connecting element, wherein the connection portion has an external diameter and a thickness smaller than a diameter external and to a thickness of the first connecting element along a section without the connecting portion.

According to an additional aspect of the invention, the second connecting element can have a respective connecting portion which extends from a free end of the second connecting element, opposite the plug, wherein the second connecting element, in correspondence with the at least a length along which the respective connecting portion extends, has an external diameter and a thickness smaller than an external diameter and a thickness of the second connecting element along a section without the respective connecting portion.

According to another aspect of the invention, the ball valve can comprise at least one hydraulic connecting element which protrudes from the first connecting element and is in fluid communication with it.

According to a further aspect of the invention, the at least one hydraulic connection element together with the body and the first connecting element can define a monobloc body without welds.

According to an additional aspect of the invention, the at least one hydraulic connecting element can be made along a section without the connection portion.

According to another aspect of the invention, the ball valve can comprise at least one closing element configured to be connected to a free end of the at least one hydraulic connecting element and to seal it.

It is also a specific object of the invention, a method for manufacturing a previously described ball valve, comprising the step of:
forming a body and a first connecting element, optionally at least one hydraulic connecting element, together by means of a single lost-wax molding process;
forming a plug and a second connecting element together through a single lost-wax molding process;
place internal components of the ball valve in the body;
connect the body and the plug;
seal the body and the plug.

The advantages offered by the ball valve according to the invention are evident.

In particular, the ball valve according to the invention has a small number of components to be mutually connected and, therefore, to be welded together.

Reducing the number of welds necessary for the connection of the ball valve components allows to limit the thermal stresses to which they are subjected, thus preserving their mechanical features and avoiding the establishment of residual internal stresses that can compromise strength and reliability.

Furthermore, reducing the total number of welds to be performed necessary for the connection of the individual components of the ball valve simplifies the production process, reducing times and allowing an increase in the production rate, as well as allowing an optimization of production costs.

The present invention will now be described, as illustrative but not limiting example, according to its preferred embodiments, with particular reference to the Figures of the attached drawings, wherein:

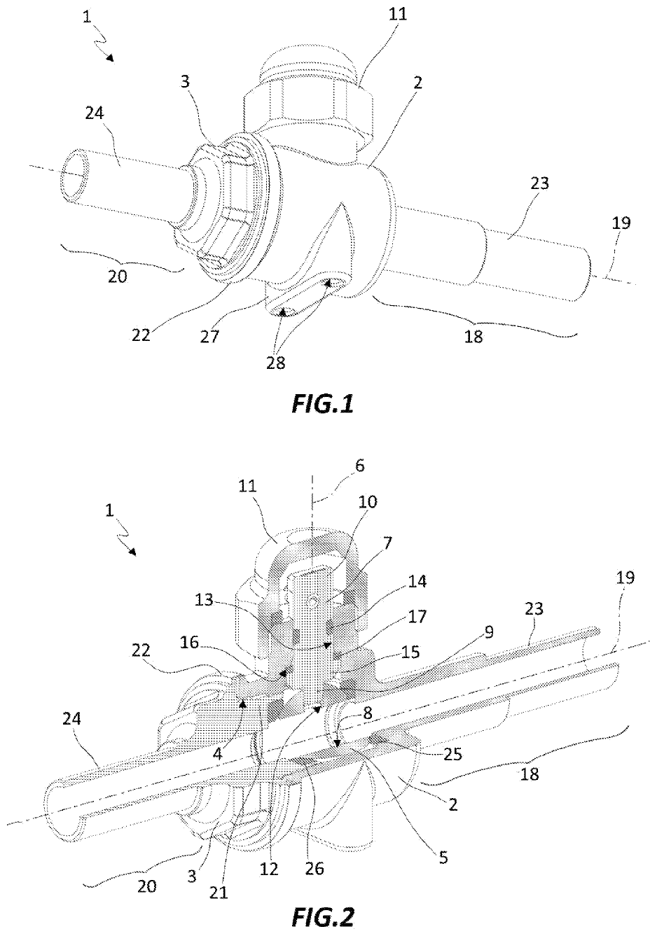

FIG. 1 shows a perspective view from below of a first embodiment of the ball valve according to the invention;

FIG. 2 shows a perspective sectional view of the ball valve of FIG. 1, taken along two consecutive section planes, orthogonal to each other;

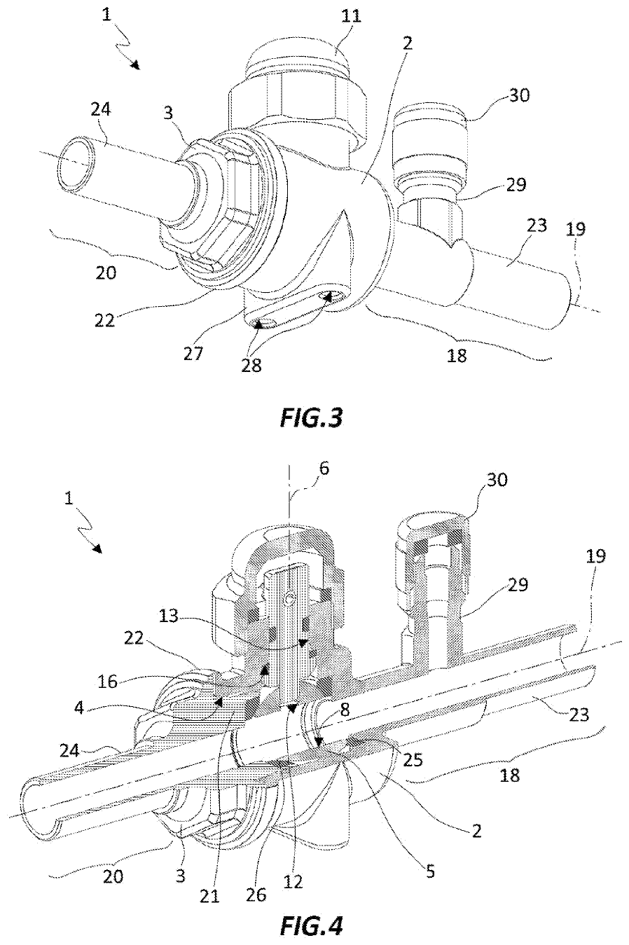

FIG. 3 shows a perspective view from below of a second embodiment of a version of a ball valve according to the invention;

FIG. 4 shows a perspective sectional view of the ball valve of FIG. 3, taken along two consecutive section planes, orthogonal to each other;

FIG. 5 shows a perspective view from below of a third embodiment of a ball valve according to the invention;

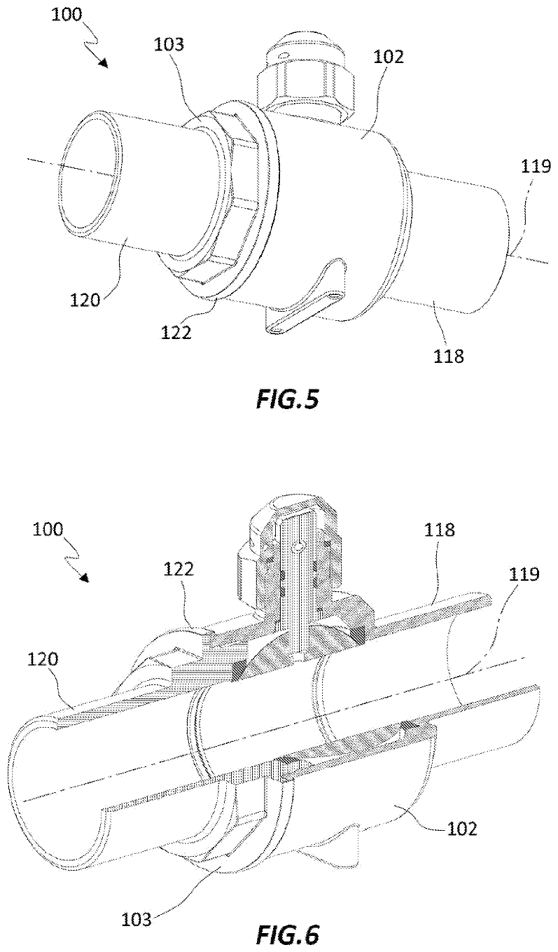

FIG. 6 shows a perspective sectional view of the ball valve of FIG. 5, taken along two consecutive section planes, orthogonal to each other;

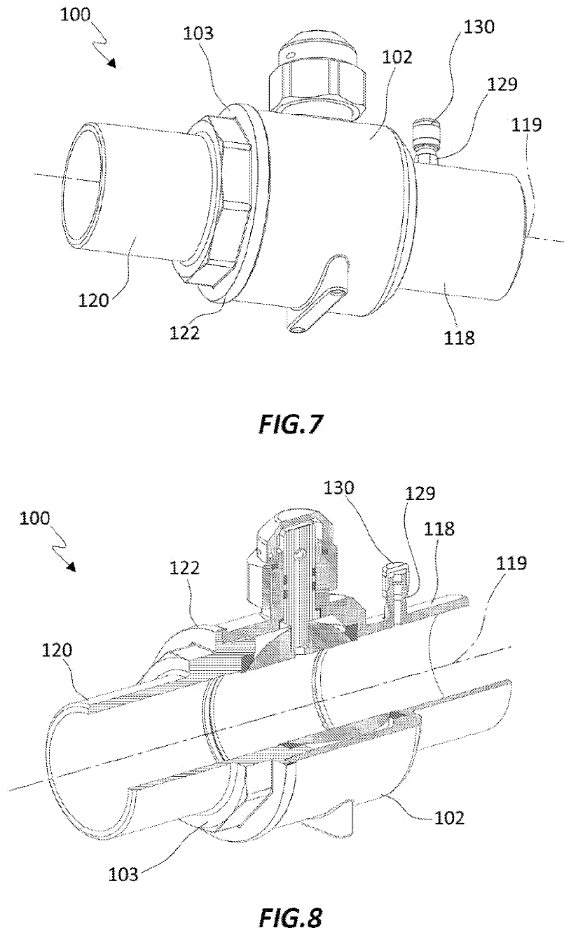

FIG. 7 shows a perspective view from below of a fourth embodiment of a ball valve according to the invention;

FIG. 8 shows a perspective sectional view of the ball valve of FIG. 7, taken along two consecutive section planes, orthogonal to each other.

In the Figures identical reference numbers will be used for similar elements

With reference to FIG. 1, a preferred embodiment of a ball valve according to the invention can be observed, wholly indicated by 1.

The ball valve 1 comprises a body 2 delimiting an internal cavity and a closing element or plug 3 configured to be connected to the hollow body 2, partially closing the internal cavity.

In particular, the plug 3 is configured to be connected at an opening 4 delimited by the body 2. Through the opening 4 it is possible to access the internal cavity of the body 2.

In turn, the plug 3 delimits an access opening in the internal cavity of the body 2.

The hollow body 2 is configured to house inside it a ball shutter 5 which can be rotated around an actuation axis 6 (see FIG. 2) by means of a control pivot 7, operatively connected to the ball shutter 5 according to modes available of the person skilled in the field which, therefore, will not be described in detail.

The ball shutter 5 defines a through opening 8 which develops centrally through it. The through opening 8 develops along a direction normal to the actuation axis 6.

The control pivot 7, in particular, has an engagement end 9 configured to engage the ball shutter 5 and an actuation end 10 configured to protrude outside the body 2 and to be operatively connected to actuation members 11, for example by means of a connecting element such as a pivot or a pin (schematically illustrated in section, such as a broken annular element, in the attached FIG. 2).

The engagement end 9 is configured to engage a seat 12 delimited at a top portion of the ball shutter 5, defining a coupling able of preventing relative rotation between the control pivot 7 and the ball shutter 5.

The control pivot 7 is rotatably housed inside an axial seat 13 delimited along a top portion of the body 2, wherein the axial seat 13 is in communication with the internal cavity in which the ball shutter 5 is housed.

The control pivot 7 hermetically engages the axial seat 13 by means of at least one annular gasket 14 housed in a respective seat delimited along an external cylindrical surface of the control pivot 7.

The control pivot 7 at the end of engagement 9 has an enlarged annular section 15, which protrudes radially from the control pivot 7.

The enlarged annular section 15 is configured to determine an axial constraint with respect to a shoulder 16 provided along the axial seat 13, keeping the control pivot 7 in position inside the axial seat 13 itself.

A further gasket 17 is interposed between the enlarged annular section 15 and the shoulder 16.

The body 2 comprises a first connecting element 18 configured as a hollow tubular element in fluid communication with the ball shutter 5.

The first connecting element 18 extends externally from the body 2, starting from one end of the same, along a flow direction 19.

The plug 3 comprises a second connecting element 20 configured as a hollow tubular element which, when the plug 3 is bound to the body 2, is in fluid communication with the ball shutter 5.

The second connecting element 20 projects externally from the plug 3 along the flow direction 19.

In practice, the first connecting element 18 and the second connecting element 20 protrude from opposite ends of the ball valve 1 and are mutually aligned along the flow direction 19.

The flow direction 19 is aligned orthogonally to the actuation axis 6.

It should be noted that the first connecting element 18 together with the body 2 define a monobloc body and, similarly, the plug 3 together with the second connecting element 20 also define a monobloc body.

The term “monobloc body” means that the body 2 together with the first connecting element 18 form a single, continuous body made of the same material, without welding. Similarly, the plug 3 together with the second connecting element 20 are a single, continuous body, made of the same material, without welding.

In other words, the body 2 and the first connecting element 18 are a single and continuous body and, similarly, the plug 3 and the second connecting element 20 are a single and continuous body, where the term “continuous” means indicate without any separation or gaps or joints (see FIGS. 2 and 4).

The body 2, in correspondence with the portion from which the first connecting element 18 protrudes, has a thickness such as to give a high mechanical resistance and to promote an optimal distribution of the stresses inside the body 2 determined by the pressure reached, in use, inside.

The plug 3 has a connecting portion 21 configured to engage the opening 4 of the body 2 and facilitate the connection, and the centering, between the plug 3 and the body 2 themselves. The connecting portion 21 protrudes from the plug 3, on the opposite side with respect to the second connecting element 20.

The connecting portion 21 has an external thread configured to engage a corresponding internal thread made in the body 2 at the opening 4.

The body 2 and the plug 3 are mutually sealed by means of a circumferential welding 22.

In the attached FIG. 2 the separation distance between the plug 3 and the body 2 along the flow direction 19 has been specially accentuated to promote the distinction between these two components.

Optionally, the first connecting element 18 has a connecting portion 23 which extends for at least a portion of the first connecting element 18 itself, along the flow direction 19.

More in detail, the connecting portion 23 extends from a free end of the first connecting element 18, opposite the body 2.

The connecting portion 23 is configured to facilitate the connection between the first connecting element 18 and a conduit to which it is intended to be connected.

The connecting portion 23 has a smaller thickness than that of the portion of the first connecting element 18 which is not affected by the connecting portion 23 itself.

By way of example, the connecting portion 23 is made by turning at least a portion of the first connecting element 18, so as to obtain an external diameter compatible with the internal diameter of a standardized hydraulic pipe to which the ball valve 1 is to be connected.

In particular, the presence of a connecting portion 23 is preferable when the ball valve 1 has reduced dimensions, to promote its connection to a standardized hydraulic duct with a reduced section.

For example, the term small size refers to a connection element 18 which has an external diameter between 10 mm and 22 mm

Optionally, the second connecting element 20 has a respective connecting portion 24 which extends for at least a portion of the second connecting element 20.

In particular, the respective connecting portion 24 extends starting from a free end of the second connecting element 20, opposite the plug 3, along the connection direction 19.

The respective connecting portion 24 fulfills the same purposes described in relation to the connection portion 23 of the first connecting element 18, to which reference is made in its entirety.

In practice, with reference to the above, the respective connecting portion 24 has a smaller external diameter, and therefore a lower thickness, than that of the portion of the second connecting element 20 which is not affected by the respective connecting portion 24.

The ball valve 1 comprises a first sealing element 25 interposed between the body 2 and the ball obturator 5 and a second sealing element 26 interposed between the plug 3 and the ball obturator 5, with the plug 3 constrained to the body 2.

The first sealing element 25 and the second sealing element 26 are each configured as an annular gasket of the type known to the person skilled in the art which, therefore, will not be further described hereinafter.

The ball valve 1 has a fixing portion 27 delimited at a bottom portion of the body 2.

The fixing portion 27 defines at least one blind opening 28 to allow the engagement of a screw or a fixing pivot, so as to secure the ball valve 1 to a support according to methods known in the field.

The attached FIGS. 3 and 4 show a further version of the ball valve 1 comprising a hydraulic connecting element 29 which extends from a portion of the first connecting element 18 and is in fluid communication with it.

In particular, the hydraulic connecting element 29 comprises a hollow tubular element that protrudes from a section of the first connecting element 18.

The hydraulic connecting element 29, together with the body 2 and the first connecting element 18, define a monobloc body.

More in detail, the hydraulic connecting element 29, the first connecting element 18 and the body 2 define a single body, without welds.

In other words, the first connecting element 18 has no welds both at the union portion with the hydraulic connecting element 29 and at the union portion to the body 2 since they, as mentioned, are made together by means of a single process for forming the body 2, thus eliminating a possible leak point for the ball valve 1. Therefore, contrary to what happens in a traditional type ball valve, the ball valve 1 has no connection welds between the hydraulic connecting element 29 and the first connecting element 18.

The ball valve 1, if it includes the hydraulic connecting element 29, comprises a closing element 30 configured to be connected to a free end of the hydraulic connecting element 29, to seal it.

By way of example, the closing element 30 is configured as a plug that can be screwed to the free end of the hydraulic connecting element 29 and comprises an internal thread configured to engage a corresponding external thread made along a portion of the free end of the connection element hydraulic connecting 29 itself.

With reference to the embodiment illustrated in the attached FIGS. 3 and 4, the hydraulic connecting element 29 extends along a direction perpendicular to the flow direction 19, although it is understood that alternative embodiments are possible wherein the hydraulic connecting element 29 is positioned inclined with respect to this direction of flow 19.

The hydraulic connecting element 29 is configured to provide a hydraulic connecting point with the first connecting element 18.

The attached FIGS. 3 and 4 illustrate a ball valve 1 which comprises a first connecting element 18 provided with a connecting portion 23 and at least one hydraulic connecting element 29 made along a portion of the first connecting element 18 which is not affected by the connecting portion 23.

It is understood that different positions are possible, for example with a position proximal to the body 2 or distal from it.

The attached FIGS. 5 to 8 illustrate further embodiments of the ball valve according to the invention, wholly indicated by 100.

In the following description, the same numbers increased by one hundred units will be used to indicate the components corresponding to those described for the previous embodiments.

The ball valve 100 differs from the previous embodiments in relation to the overall dimensions or, in other words, in relation to the proportions between the body 102, the first connecting element 118 and the second connecting element 120.

The first connecting element 118 and the second connecting element 120 are also aligned along the flow direction 119 and extend to opposite sides of the valve 100.

Similarly to what has been described in relation to the previous embodiment, the first connecting element 118 together with the body 102 together define a single monobloc, without welds.

The second connecting element 120 and the plug 103, in turn, together define a single body or a single monobloc, without welds.

The body 102 and the plug 103 are mutually sealed by means of a circumferential welding 122.

Optionally, the first connecting element 118 has a hydraulic connecting element 129 which protrudes from it, according to the same methods and for the same purposes described in relation to the previous embodiment, to which reference is made (see FIGS. 7 and 8).

The hydraulic connecting element 129 forms a monobloc body with the first connecting element 118 and the body 102. The monobloc body has no welds and, therefore, has no leakage points thus ensuring a perfect hydraulic seal.

The ball valve 100 comprising a hydraulic connecting element 129 also includes a closing element 130 configured to be connected to a free end of the hydraulic connecting element 129 itself, sealed.

The body 2, 102 and the plug 3, 103 of the ball valve 1, 100 are made of metal.

The body 2, 102 and the plug 3, 103 are made of stainless steel. Consequently, also the first connecting element 18, 118, the hydraulic connecting element 29, 129, if present, and the second connecting element 20, 120 are also made of stainless steel being formed as monoblocs respectively with the body 2, 102 and plug 3, 103.

The body 2, 102, the first connecting element 18, 118, and the hydraulic connecting element 29, 129 if present, as well as the plug 3, 103 and the second connecting element 20, 120 are made by means of a molding process of lost-wax, to obtain a first monobloc body and a second monobloc body to be connected together, as said by means of a circumferential welding 22, 122 to obtain the ball valve 1.

It is understood that alternative embodiments are possible in which the body 2, 102, the first connecting element 18, 118, the plug 3, 103, the second connecting element 20, 120 and, if present, the hydraulic connecting element 29, 129 are made of a different metal, for example aluminum.

According to this embodiment, the body 2, 102, the first connecting element 18, 118, the plug 3, 103, the second connecting element 20, 120 and, if present, the hydraulic connecting element 29, 129 are made by molding or die casting.

With reference to what has been described above, it should be noted that the invention also relates to a method for manufacturing a ball valve 1, 100 described above.

The method comprises a step of forming a body 2, 102, a first connecting element 18, 118, optionally at least one hydraulic connecting element 29, 129.

The step of forming the body 2, 102 comprises forming the body 2, 102 together with the first connecting element 18, 118 and optionally with the at least one hydraulic connecting element 29, 129, so as to obtain a monobloc, through a single process of lost wax molding.

The method comprises a step of forming a plug 3, 103 and a second connecting element 120.

In particular, this forming step comprises forming the plug 3, 103 together with the second connecting element 20, 120, so as to obtain a monobloc, by means of a single lost-wax molding process.

The body 2, 102 and the plug 3, 103 are then joined together in a permanent seal, by means of a single circumferential weld 22, 122.

Prior to carrying out the circumferential welding 22, 122 and connecting the plug 3, 103 to the body 2, 102, the first sealing element 25, the control pivot 7 with the relative gasket rings 14 and the ball shutter 5 are positioned inside the body 2, 102 according to a manner available to the person skilled in the art.

The ball valve 1, 100 thus made has a high structural homogeneity which provides to it a high mechanical strength capable of operating at high pressures, by way of example equal to about 150/160 bar.

The presence of a single circumferential weld 22, 122 for the connection between the body 2, 102 and the plug 3, 103 ensures the hydraulic seal and reduces the assembly and production times of the ball valve 1, 100 compared to those required for the production of traditional type ball valves including three or four welds for the reciprocal connection of the single components.

Furthermore, it should be noted that the body 2, 102 and the plug 3, 103 have high thicknesses in correspondence with the portion subjected to the circumferential welding 22, 122, thus allowing the stresses induced by this process to be uniformly distributed, without compromising the resistance of the ball valve 1, 100.

The person skilled in the art will easily understand how a ball valve 1, 100 according to the invention is able to achieve the intended purposes, having a robust and easy-to-make structure comprising a single weld.

As mentioned, in the solutions of the prior art, on the contrary, there are several welds for the reciprocal connection between the individual components.

In the foregoing, the preferred embodiments have been described and variants of the present invention have been suggested, but it is to be understood that those skilled in the art will be able to make modifications and changes without thereby departing from the relative scope of protection, as defined by the claims attached.

1. A ball valve, comprising:
a body delimiting an internal cavity,
a plug configured to be permanently connected to said body for partially closing said internal cavity,
said body being configured to house in said internal cavity a ball shutter which can be rotated around an actuation axis,
wherein said body comprises a first connecting element configured as a hollow tubular element in fluid communication with said ball shutter,
wherein said plug comprises a second connecting element configured as a hollow tubular element which, when said plug is constrained to said body, is in fluid communication with said ball shutter, and
wherein said body and said first connecting element together define a monobloc body without welds and wherein said plug and said second connecting element define together a monobloc body without welds.

2. The ball valve according to claim 1, wherein said body and said first connecting element are a monobloc and continuous body and wherein said plug and said second connecting element are a monobloc and continuous body.

3. The ball valve according to claim 1, wherein said body and said plug are mutually sealed by means of a circumferential welding.

4. The ball valve according to claim 1, wherein said first connecting element and said second connecting element protrude from opposite ends of said valve, mutually aligned along a flow direction.

5. The ball valve according to claim 1, wherein said body and said plug are steel made.

6. The ball valve according to claim 1, wherein said first connecting element has a connecting portion which extends for at least a portion of said first connecting element, wherein said connecting portion has an external diameter and a smaller thickness with respect to an external diameter and to a thickness of said first connecting element along a section without said connecting portion.

7. The ball valve according to claim 1, wherein said second connecting element has a respective connecting portion which extends from a free end of said second connecting element, opposite to said plug, wherein said second connecting element, at said at least one length along which said respective connecting portion extends, has an external diameter and a thickness smaller than an external diameter and a thickness of said second connecting element along a section without said respective connecting portion.

8. The ball valve according to claim 1, comprising at least one hydraulic connecting element which extends from said first connecting element and is in fluid communication with it.

9. The ball valve according to claim 8, wherein said at least one hydraulic connecting element together with said body and said first connecting element define a monobloc body without welds.

10. The ball valve according to claim 6, comprising at least one hydraulic connecting element which extends from said first connecting element and is in fluid communication with it, wherein said at least one hydraulic connecting element is made along a section without said connecting portion.

11. The ball valve according to any one of claim 8, comprising at least a closing element configured to be connected to a free end of said at least one hydraulic connecting element and to seal it off.

12. A method for realization of a ball valve according to claim 1, comprising:
forming a body and a first connecting element, optionally at least one hydraulic connecting element, together by means of a single lost-wax molding process;
forming a plug and a second connecting element together by means of a single lost-wax molding process;
positioning internal components of said ball valve in said body;
connecting said body and said plug; and
sealing said body and said plug.
